(19) United States
(12) Patent Application Publication
(10) Pub. No.: US 2017/0057055 A1
(43) Pub. Date: Mar. 2, 2017

(54) PRESS-FIT WRENCH CAPABLE FOR REPETITIVE OPERATION

(71) Applicant: YU-TU HSU, Taichung City (TW)

(72) Inventor: YU-TU HSU, Taichung City (TW)

(21) Appl. No.: 14/833,150

(22) Filed: Aug. 24, 2015

(51) Int. Cl. B25B 13/28

(52) U.S. Cl. CPC B25B 13/28

(57) ABSTRACT

A press-fit wrench capable for repetitive operation is disclosed and comprises a driving handle, a ring sleeve member, and an elastic member. A screw or nut is passing through the sleeve hole and the push portion and a wall of the sleeve hole are stopped against a side of the screw or nut to cooperate with the driving handle to repetitively pivot through the arrangement of the driving handle and the ring sleeve member so that the push portion and the wall of the sleeve hole are capable for stopping against the screw or nut with tight engagement and the elastic member is capable for making the ring sleeve member skip to release engagement for smooth and quick operation.

### BACKGROUND OF THE INVENTION

1. Field of the Invention

The present invention relates to a press-fit wrench capable for repetitive operation, and especially relates to a wrench capable for continuously and repetitively pivoting to screw in and out the screw or nut so as to reduce operating time and make the operation more smoothly.

2. Description of Related Art

Taking a broad view of the industry development, hand tools are the indispensable tools. Most of machines, buildings, and objects are assembled with screws. The screw and the nut are screwed with each other with the threading structure so that the assembling structure is not easy to be disassembled and released. Therefore, the hand tools are the only one tool for making the screw screw in and out the nut. There are many types of hand tools, but the wrench is a main choice. The wrench may be an open-end wrench, box wrench, ratchet wrench, and etc. each wrench has its own specific using method. Basically, when a user screws the screw in or out the nut, an electrical tools may be a first choice if there are an electric supply and a socket. If there is no electric supply and socket, the user must use the wrench to operate. Most of the users may directly choose the box wrench or open-end wrench due to easy operation and convenience for carrying.

Although the box wrench and the open-end wrench have above mentioned advantages, there is a disadvantage that the user must continuously screw the screw or nut while screwing in or out. The method of continuously screwing is that the user must hold the wrench to leave the screw or nut and then to sleeve the screw or nut. The operation must be repeated for each screwing. The screw or nut may be smoothly screwed in or out by repeating above mentioned operations. It may increase the operating time. And if the wrench is not aligned with the screw or nut, it will not be screwed in or out. Therefore, the conventional box wrench and the open-end wrench need to be improved.

In view of the foregoing circumstances, the inventor has invested a lot of time to study the relevant knowledge, compare the pros and cons, research and develop related products. After quite many experiments and tests, the “press-fit wrench” of this invention is eventually launched to improve the foregoing shortcomings, to meet the public use.

### SUMMARY OF THE INVENTION

An object of this invention is providing a press-fit wrench capable for repetitive operation. It may provide a user to reduce operating time and decrease the processes and steps of operation while screwing or out the screw or nut. It may quickly and easily to screw in and out. It may improve the problems of wasting operating time and too much processes and steps of operation of the box wrench and the open-end wrench.

In order to achieve above mentioned object, a press-fit wrench capable for repetitive operation is provided. The wrench may comprise a driving handle, one end thereof has a push portion and a receiving groove, the other end thereof has a holding port, and further a pivot hole is passing through the driving handle and arranged between the push portion and the receiving groove; a ring sleeve member, a sleeve hole is passing through the ring sleeve member, and a cutting hole is arranged at a peripheral of the ring sleeve member and fluidly communicated with the sleeve hole, the end of the driving handle having the push portion is inserted into the cutting hole and part of the push portion is exposed into the sleeve hole, a through hole is formed at the ring sleeve member corresponding to the pivot hole, and a bolt is passing through the through hole and the pivot hole; and an elastic member, accommodated in the receiving groove, one end of the elastic member is against the receiving groove and the other end thereof is against a wall surface of the cutting hole; wherein a screw or nut is passing through the sleeve hole and the push portion and a wall of the sleeve hole are stopped against a side of the screw or nut to cooperate with the driving handle to repetitively pivot through the arrangement of the driving handle and the ring sleeve member so that the push portion and the wall of the sleeve hole are capable for stopping against the screw or nut with tight engagement and the elastic member is capable for making the ring sleeve member skip to release engagement for smooth and quick operation.

In some embodiments, the push portion of the driving handle further includes a plurality of convex teeth, and the convex teeth are spaced apart from each other and formed a plurality of concave grooves.

In some embodiments, the ring sleeve further include a meshing portion, the meshing portion has a plurality of sharp teeth connected with each other, and a plurality of concave sharp grooves are formed between two adjacent sharp teeth for each.

In some embodiments, the push portion and the wall of the sleeve hole are surrounded to form a hexagon or a polygon.

In some embodiments, an opening is further formed on the ring sleeve member.

In conclusion, when a user wants to screw out the screw or nut, the sleeve hole of the ring sleeve member must be aligned with the screw or nut so that the meshing portion of the ring sleeve member and the push portion of the driving handle may ensure to stop against the side of the screw or nut. And then, the holding portion is controlled to pivot the push portion and the pivot of the driving handle makes the push portion and the meshing portion certainly stop against the screw or nut to pivot. And when the user continues controlling the screw or nut to operate, the driving handle is regressively pivoted after progressively pivoting to compress one end of the elastic member and the other end of the elastic member is removed and pushed toward a hole wall of the cutting hole of the ring sleeve member so that the meshing portion of the ring sleeve member may be released from stopping against the screw or nut due to the arrangement of the elastic member when the driving handle is regressively pivoted to make the meshing portion is skipped the screw or nut. Therefore, after the driving handle is progressively and regressively pivoted, the user may continue operating without releasing the screw or nut until the screw or nut is screwed in or out.

The various objectives and advantages of the present invention will be more readily understood from the following detailed description when read in conjunction with the appended drawing.

### BRIEF DESCRIPTION OF THE DRAWINGS

FIG. 1 is a perspective view of a press-fit wrench capable for repetitive operation of the present invention;

FIG. 2 is an exploded view of the wrench of the present invention;

FIG. 3 is a cross-sectional view of the wrench of the present invention;

FIG. 4 is a cross-sectional view of the wrench of the present invention while in operation;

FIG. 5 is a view of the wrench of the present invention while the driving handle is pivoted progressively;

FIG. 6 is a view of the wrench of the present invention while the driving handle is pivoted regressively;

FIG. 7 is a perspective view of the wrench of the present invention which has various teeth types;

FIG. 8 is a perspective view of another embodiment of the press-fit wrench capable for repetitive operation of the present invention;

FIG. 9 is a perspective view of the wrench of the present invention which is arranged a D-shaped head while in operation;

FIG. 10 is a cross-sectional view of the driving handle and the ring sleeve member of FIG. 9;

FIG. 11 is a perspective view of the wrench of the present invention while the push portion and the meshing portion are surrounded to form a hexagon.

FIG. 12 is a cross-sectional view of FIG. 11;

FIG. 13 is cross-sectional view of FIG. 12 which is screwed a screw; and

FIG. 14 is a perspective view of the wrench of the present invention while the sleeve hole is a round shape.

### DETAILED DESCRIPTION OF THE INVENTION

To describe clearly that the present invention achieves the foregoing objective and function, the technical features and desired function are described with reference to a preferred embodiment and accompanying drawings.

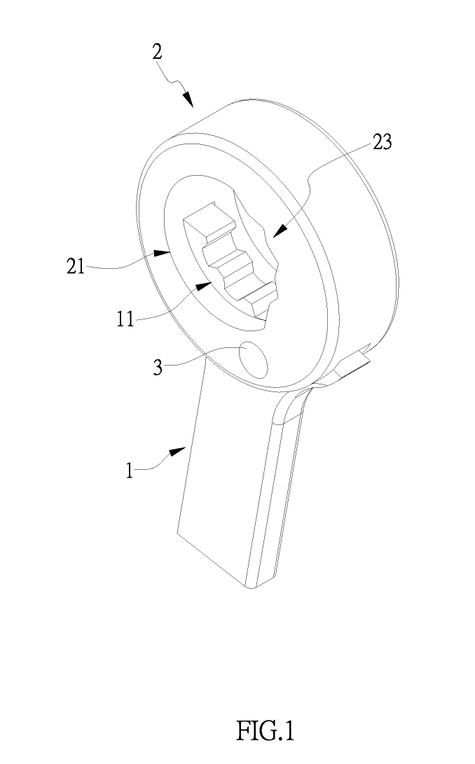

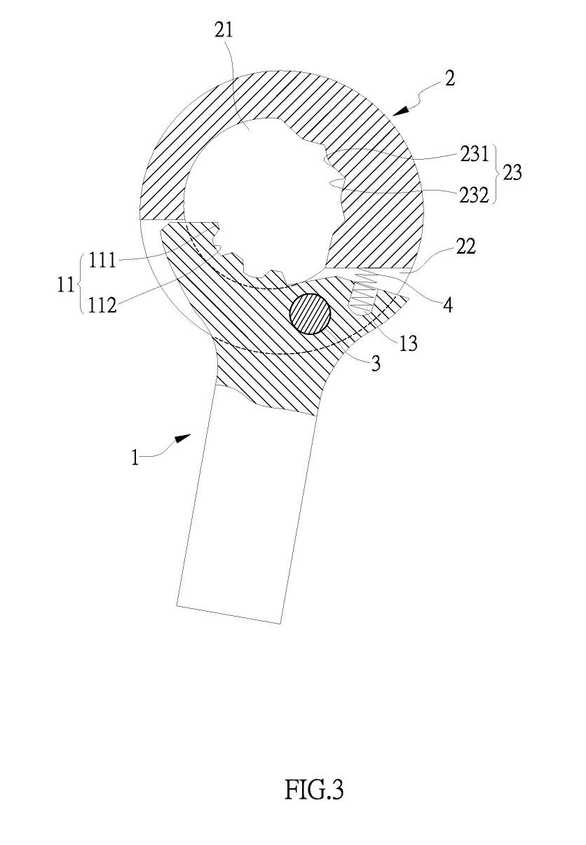

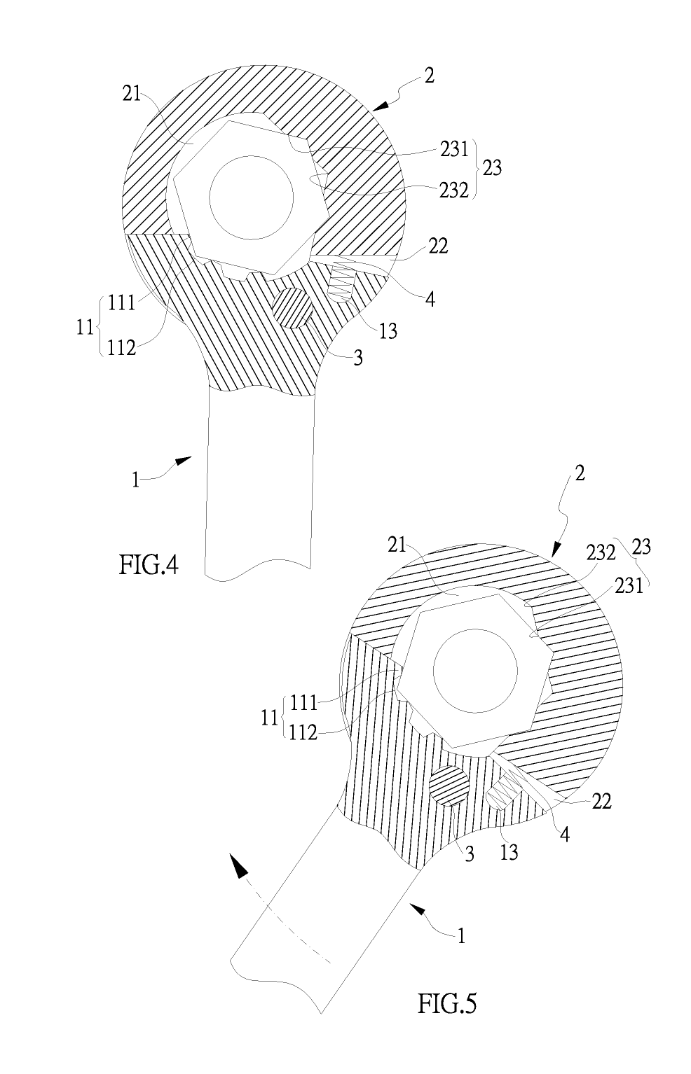

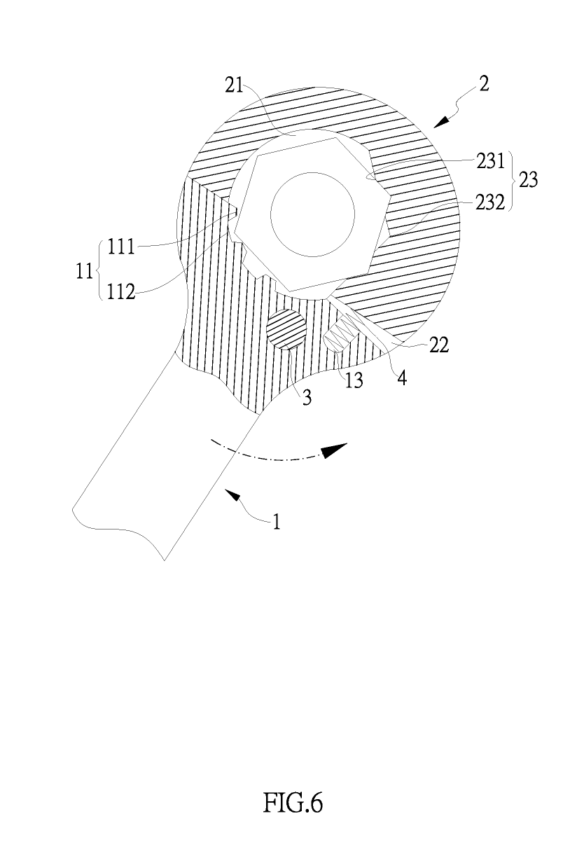

Please reference to FIGS. 1 to 6, a press-fit wrench capable for repetitive operation of present invention may comprise a driving handle 1, a ring sleeve member 2, and an elastic member 4. One end of the driving handle 1 has a push portion 11 and the other end thereof has a holding port 12 which is connected with the push portion 11. The end of the driving handle 1 having the push portion 11 is concave arc. And the side of the driving handle 1 having the push portion 11 is concavely arranged a receiving groove 13. And further a pivot hole 14 is passing through the driving handle 1 and arranged between the push portion 11 and the receiving groove 13. A sleeve hole 21 is passing through the ring sleeve member 2 and a cutting hole 22 is arranged at a peripheral of the ring sleeve member 2 and fluidly communicated with the sleeve hole 21. The length of the cutting hole 22 may be provided the end of the driving handle 1 which has the push portion 11 for passing through. The end of the driving handle 1 which has the push portion 11 is inserted into the cutting hole 22 and part of the push portion is exposed into the sleeve hole 21. A meshing portion 23 may be arranged at a wall surface of the sleeve hole 21 for connecting with the cutting hole 22. A through hole 24 is formed at the ring sleeve member 2 corresponding to the pivot hole 14. A bolt 3 is passing through the through hole 24 and the pivot hole 14 so that the ring sleeve member 2 and the driving handle 1 are pivotably arranged. The elastic member 4 is accommodated in the receiving groove 13. One end of the elastic member 4 is against the bottom of the receiving groove 14 and the other end of the elastic member 4 is against a side wall surface of the cutting hole 22. A screw or nut is passing through the sleeve hole 21 and the push portion 11 and the meshing portion 23 are stopped against a side of the screw or nut to cooperate with the driving handle 1 to repetitively pivot through the arrangement of the driving handle 1 and the ring sleeve member 2 so that the push portion 11 and meshing portion 23 are capable for stopping against the screw or nut with tight engagement and the elastic member 4 is capable for making the ring sleeve member 2 skip to release engagement for smooth and quick operation.

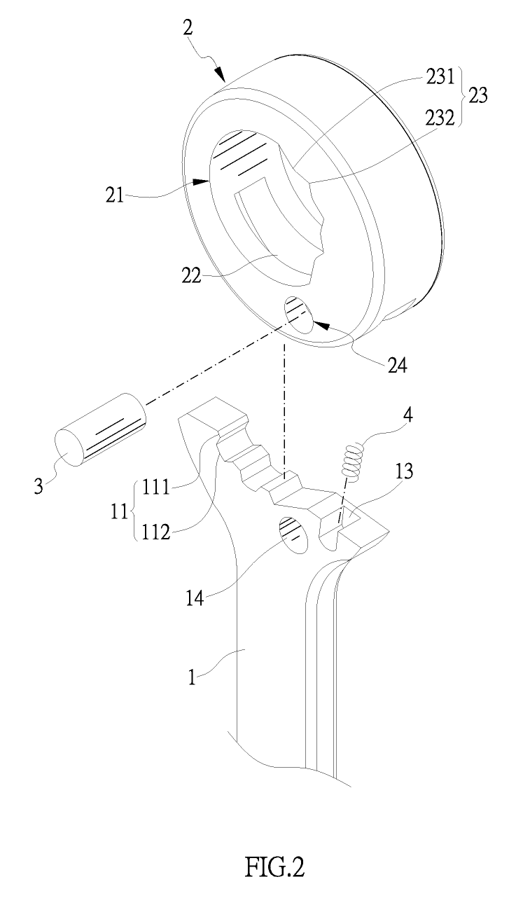

According to above mentioned, when a user wants to screw out the screw or nut, the sleeve hole 21 of the ring sleeve member 2 must be aligned with the screw or nut so that the meshing portion 23 of the ring sleeve member 2 and the push portion 11 of the driving handle 1 may ensure to stop against the side of the screw or nut (in prior art, the screw or nut are a polygon, and the descriptions are omitted). And then, the holding portion 12 is controlled to pivot the push portion 11 and the pivot of the driving handle 1 makes the push portion 11 and the meshing portion 23 certainly stop against the screw or nut to pivot. And when the user continues controlling the screw or nut to operate, the driving handle 1 is regressively pivoted after progressively pivoting to compress one end of the elastic member 4 and the other end of the elastic member 4 is removed and pushed toward a hole wall of the cutting hole 22 of the ring sleeve member 2 so that the meshing portion 23 of the ring sleeve member 2 may be released from stopping against the screw or nut due to the arrangement of the elastic member 4 when the driving handle 1 is regressively pivoted to make the meshing portion 23 is skipped the screw or nut. Therefore, after the driving handle 1 is progressively and regressively pivoted, the user may continue operating without releasing the screw or nut until the screw or nut is screwed in or out (shown as in FIGS. 2, 5, and 6).

In addition, the wrench may be tightly stopped against the screw or nut through the arrangement of the push portion 11 of the driving handle 1 and the meshing portion 23 of the ring sleeve member 2 to achieve the effects of screwing in and out. And, the user may continue operating the wrench due to the arrangement of the elastic member 4 to reduce the operating time. Therefore, the arrangement of the push portion 11 and the meshing portion 23 is much more important. The push portion 11 of the driving handle 1 further includes a plurality of convex teeth 111. The convex teeth 111 are arranged along one end of the driving handle 1 and spaced apart from each other. A plurality of concave grooves 112 are formed between two adjacent convex teeth 111 for each. The meshing portion 23 of the ring sleeve member 2 corresponding to the push portion 11 further includes a plurality of sharp teeth 231. Each of the sharp teeth 231 are connected with each other and formed a plurality of sharp concave grooves 232 which are arranged between two adjacent sharp teeth for each. In conclusion, when the screw or nut is sleeves by the wrench, the side of the screw or nut may be stopped against one of the concave grooves 112 of the push portion 11 and engaged with the concave grooves 112 of the meshing portion 23. The push portion 11 and the meshing portion 23 may make sure drive the screw or nut through the eccentric arrangement of the sleeve hole 21 and the control of the driving handle 1 according to the pivot direction of the driving handle 1 to achieve the effects of screwing in and out. Furthermore, the wrench is not necessary to pulled out from the screw or nut due to the arrangement of the elastic member 4 while the user is controlling so as to reduce the operating time and decrease the processes and steps of operation (shown as in FIGS. 2, 3, and 5.

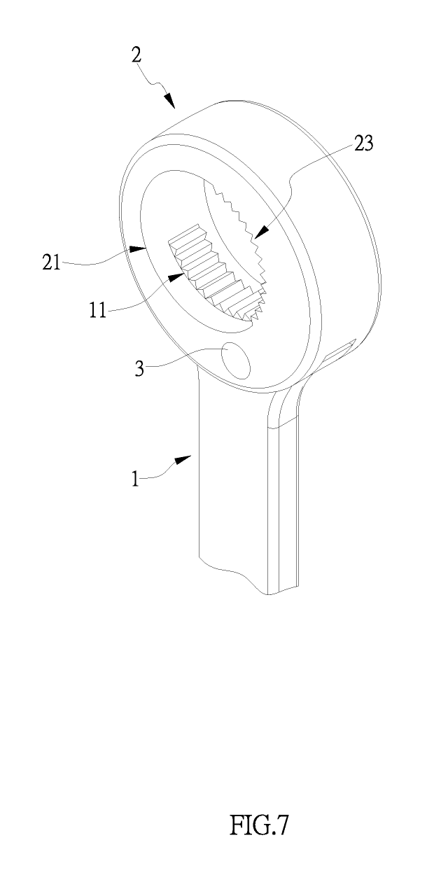

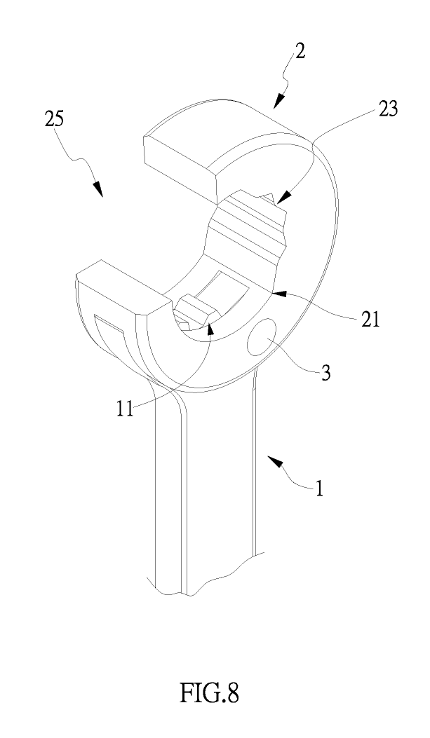

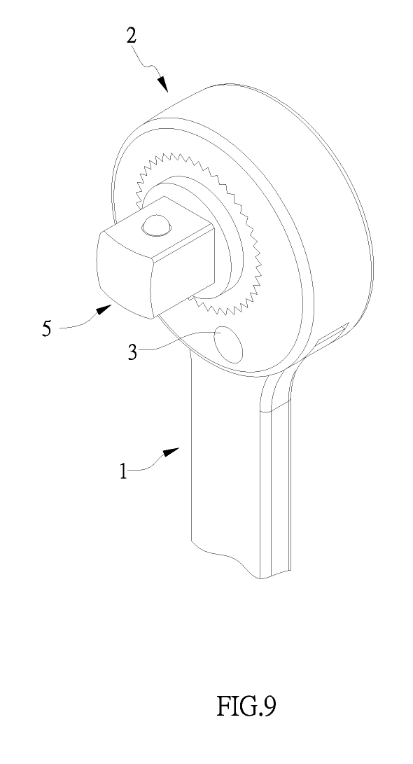

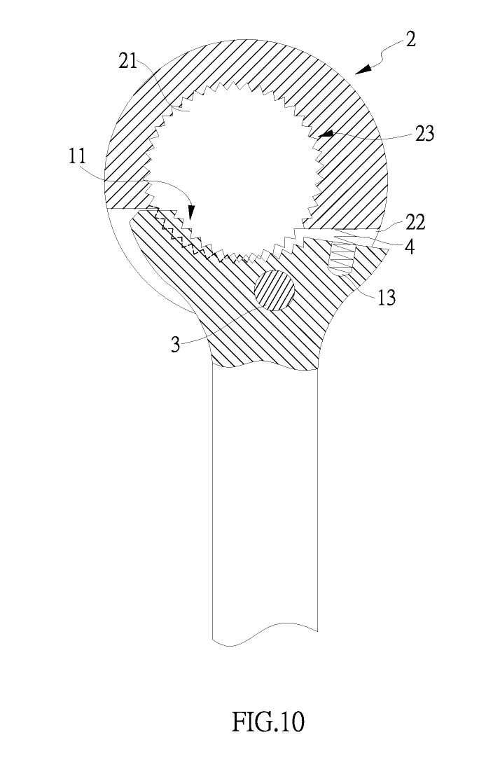

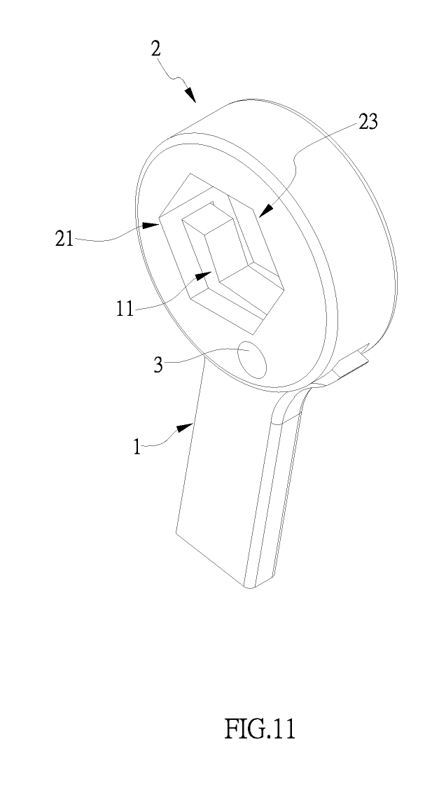

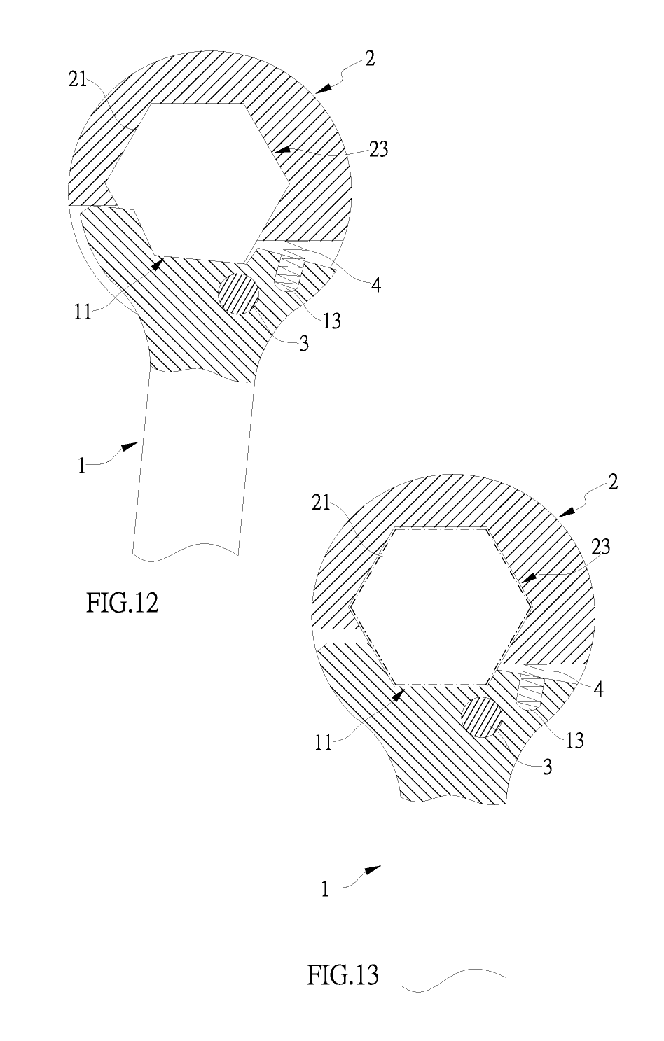

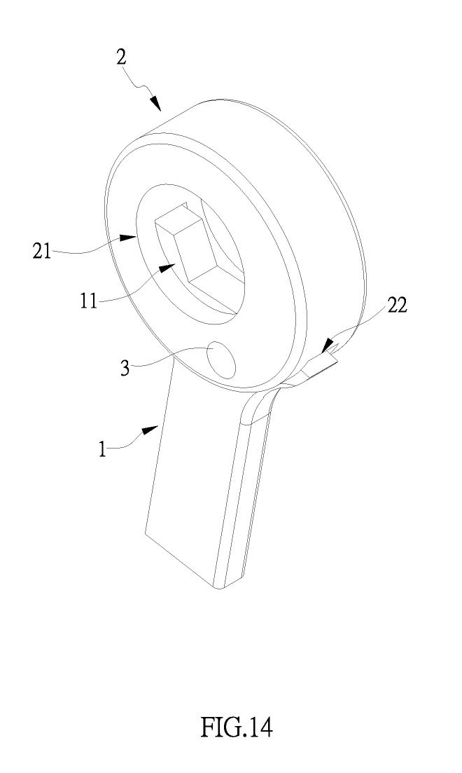

Please refer to FIG. 7, in order to cooperate with the shape of the screw or nut, the arrangement of the convex teeth 111 of the push portion 11, the concave grooves 112, the sharp teeth 231 of the mesh portion 23, and the sharp concave groove 232 may be various. In FIG. 7, the pitches of the push portion 11 and the meshing portion 23 are much closer and the shapes of the teeth are sharp convex shape. Therefore, it may control the screw or nut with various shapes for screwing in and out. Please refer to FIG. 8, besides the ring sleeve member 2 is ring shape, it may be C shape and formed an opening 25. Please refer to FIGS. 9 and 10, the wrench may further arrange a D-shaped head 5. A conventional S-shaped head 5 is used for providing a barrel to assemble. A row of teeth 51 may be arranged at a peripheral of the D-shaped head. The row of teeth 51 may be engaged with the push portion 11 and the meshing portion 23. Please refer to FIG. 11, besides showing the designs of the push portion 11 and the meshing portion 23 in FIGS. 1, and 7 to 9, they may be surrounded to form a hexagon to tightly sleeve on the head of the screw to pivot repetitively. The FIGS. 11 to 13 are illustrated with the hexagon, but not limited thereto. They may be a polygon (not shown). Please refer to FIG. 14, the sleeve hole 21 may be designed to be a type of round hole and mainly limited the screw or nut to be positioned by the push portion 11 and the hole wall of the sleeve hole 21 so that the side of the screw or nut may be against the hole wall of the sleeve hole 21 and further cooperated with the push portion 11 to engage to make sure pivot.

The foregoing descriptions are merely the exemplified embodiments of the present invention, where the scope of the claim of the present invention is not intended to be limited by the embodiments. Any equivalent embodiments or modifications without departing from the spirit and scope of the present invention are therefore intended to be embraced.

The disclosed structure of the invention has not appeared in the prior art and features efficacy better than the prior structure which is construed to be a novel and creative invention, thereby filing the present application herein subject to the patent law.

What is claimed is:

1. A press-fit wrench capable for repetitive operation comprising:
a driving handle, one end thereof has a push portion and a receiving groove, the other end thereof has a holding port, and further a pivot hole is passing through the driving handle and arranged between the push portion and the receiving groove;
a ring sleeve member, a sleeve hole is passing through the ring sleeve member, and a cutting hole is arranged at a peripheral of the ring sleeve member and fluidly communicated with the sleeve hole, the end of the driving handle having the push portion is inserted into the cutting hole and part of the push portion is exposed into the sleeve hole, a through hole is formed at the ring sleeve member corresponding to the pivot hole, and a bolt is passing through the through hole and the pivot hole; and
an elastic member, accommodated in the receiving groove, one end of the elastic member is against the receiving groove and the other end thereof is against a wall surface of the cutting hole;
wherein a screw or nut is passing through the sleeve hole and the push portion and a wall of the sleeve hole are stopped against a side of the screw or nut to cooperate with the driving handle to repetitively pivot through the arrangement of the driving handle and the ring sleeve member so that the push portion and the wall of the sleeve hole are capable for stopping against the screw or nut with tight engagement and the elastic member is capable for making the ring sleeve member skip to release engagement for smooth and quick operation.

2. The wrench as claimed in claim 1, wherein the push portion of the driving handle further includes a plurality of convex teeth, and the convex teeth are spaced apart from each other and formed a plurality of concave grooves.

3. The wrench as claimed in claim 1, wherein the ring sleeve further include a meshing portion, the meshing portion has a plurality of sharp teeth connected with each other, and a plurality of concave sharp grooves are formed between two adjacent sharp teeth for each.

4. The wrench as claimed in claim 2, wherein the ring sleeve further include a meshing portion, the meshing portion has a plurality of sharp teeth connected with each other, and a plurality of concave sharp grooves are formed between two adjacent sharp teeth for each.

5. The wrench as claimed in claim 1, wherein the push portion and the wall of the sleeve hole are surrounded to form a hexagon or a polygon.

6. The wrench as claimed in claim 3, wherein the push portion and the meshing portion are surrounded to form a hexagon or a polygon.

7. The wrench as claimed in claim 4, wherein the push portion and the meshing portion are surrounded to form a hexagon or a polygon.

8. The wrench as claimed in claim 1, wherein an opening is further formed on the ring sleeve member.

9. The wrench as claimed in claim 6, wherein an opening is further formed on the ring sleeve member.
